(19) United States
(12) Patent Application Publication
(10) Pub. No.: US 2025/0187384 A1
(43) Pub. Date: Jun. 12, 2025

(54) Leaf Spring Bracket

(71) Applicant: SUMITOMO RIKO COMPANY LIMITED, Aichi (JP)

(72) Inventors: Jozsef KONDOR, Künzell (DE); Bulut CIFTCI, Steinau an der Straße (DE)

(21) Appl. No.: 18/974,226

(22) Filed: Dec. 9, 2024

(30) Foreign Application Priority Data
Dec. 12, 2023 (DE) 10 2023 134 792.6
Nov. 27, 2024 (DE) 10 2024 135 064.4

(51) Int. Cl. B60G 11/12

(52) U.S. Cl. CPC B60G 11/12; B60G 2204/121; B60G 2204/41

(57) ABSTRACT

The invention relates to a bracket for a leaf spring on a vehicle frame, wherein a leaf spring linkage is provided via which an eye of the leaf spring is held, wherein a spring eye bearing is provided which is inserted into the eye of the leaf spring, wherein a connecting portion is also provided which connects the leaf spring linkage to the vehicle frame, while at least one connection bushing is provided via which the connecting portion can be mounted on the vehicle frame, wherein the connection bushing which comprises a damping sleeve is interposed in a damping manner between the connecting portion and the vehicle frame.

The invention relates to a bracket for a leaf spring on a vehicle frame according to the preamble of patent claim 1, wherein the leaf spring is held at its end via a leaf spring eye. The spring eye is mounted on the bracket via a spring eye bearing, wherein the spring eye bearing is connected to the vehicle frame via a connecting portion. The connecting portion is mounted on the vehicle frame.

Examples of the type described above are known from the prior art. EP 0 615 869 B1, for example, discloses a single-side bracket for a leaf spring on a vehicle frame, wherein a spring eye bearing is inserted into the leaf spring eye which consists of an elastic sleeve and a metal sleeve vulcanised into it. The elastic sleeve serves to damp vibrations and audible noises emanating from parts connected to each other in a vehicle and/or to also neutralise impacts to a certain extent, wherein the bracket described here is rigidly connected to the vehicle frame, and frequencies transmitted by the leaf spring are transmitted onto the vehicle frame only in a damped manner by the elastic sleeve.

EP 1 600 312 A1 likewise discloses a bracket for a leaf spring, in which a recess which is provided in the vehicle frame or as a separate part receives a spring eye bearing which is constructed in a similar way to the spring eye bearing in accordance with the prior art referenced above. The sequence of layers has merely been altered in this case, i.e. an elastic sleeve firstly encloses a retaining bolt, and the elastic sleeve is surrounded by a metal sleeve. Here, again, the frequency spectrum emanating from the leaf spring is damped by the elastic sleeve only.

The object of the present invention is to provide a simple single-side bracket for a leaf spring on a vehicle frame, which can advantageously absorb and therefore damp vibrations in the disruptive range. The bracket should be used at both ends of the leaf spring.

In accordance with the invention, the bracket in accordance with the invention comprises the features cited in patent claim 1, including at least one connection bushing via which the connecting portion is fixed to the vehicle frame. The bracket arrangement in accordance with the invention advantageously comprises more than one connection bushing, for example two, three or four connection bushings.

This arrangement of the bracket in accordance with the invention provides the advantage that the existing spring eye bearing in combination with the connection bushing or bushings provides surprisingly good damping over a substantial frequency range which can lead to unpleasant vibrations and noise, especially in motor vehicles comprising conventional leaf spring brackets. This applies both to vehicles powered by an internal combustion engine and to vehicles powered by an electric motor and/or to hybrid-powered vehicles, since not only the engines but also the transmissions and especially their gears cause noise and vibrations in the audible range during operation.

In accordance with the invention, a bracket for a leaf spring on a vehicle frame is proposed which, in addition to a leaf spring linkage via which an eye of the leaf spring is held, a spring eye bearing which is inserted into the eye of the leaf spring, a connecting portion which connects the leaf spring linkage to the vehicle frame, and at least one connecting device via which the connecting portion can be mounted on the vehicle frame, is characterized in that the connecting device comprises a damping sleeve which is interposed in a damping manner between the connecting portion and the vehicle frame.

It is in particular proposed that two connecting devices of the type indicated be provided, arranged to the right and left of the connecting portion, or that four of them be provided, preferably two each to the right and left of the connecting portion.

The arrangement of the spring eye bearing on the one hand, and the connection bushings on the other, enable the frequency spectrum of the transmitted vibrations to be restricted, wherein it is essential that the design and mass of the bracket in accordance with the invention can aid in making the natural frequencies of the bracket in accordance with the invention suitable for preventing the spread of distruptive vibrations or noise generated by a device beyond the leaf spring.

The damping sleeve of the connection bushing is then advantageously embodied to be vertically and/or laterally resilient, thus enabling a damping characteristic to be provided. If there are multiple connecting devices and therefore multiple damping sleeves, the damping sleeves can also be embodied differently in order to be adapted to specific vibration spectra or frequency spectra which can emanate from a source of vibration or noise.

A support sleeve is advantageously provided to which the connecting portion is attached and which rests on the connection bushing. In this way, the damping sleeve can be subjected to a load more uniformly.

Conversely, in the case of vertical assembly, it can be advantageous to provide an abutting sleeve which the connecting portion laterally rests on and which laterally rests on the connection bushing.

If an abutting sleeve is provided, it can be embodied to be vertically narrower than the damping sleeve.

If the abutting sleeve is used, it can be advantageous for a gap to be provided vertically between the abutting sleeve and the vehicle frame and/or between the abutting sleeve and an outer flange.

The support sleeve can advantageously be embodied to be laterally narrower, i.e. in this case narrower in the X direction, than the damping sleeve, i.e. the damping sleeve protrudes below both ends of the support sleeve which is in particular a hollow-cylindrical support sleeve. In this way, vibrations transmitted by the leaf spring can be kept away from the connecting portion, in order to reduce vibrations and noise.

Within this context, it is advantageous if a gap is provided laterally between the support sleeve and the vehicle frame and/or between the support sleeve and an outer flange of the connection bushing. This can aid in eliminating a vibration-transmitting or noise-transmitting contact.

The leaf spring linkage can advantageously be arranged at least substantially vertically below the at least one connection bushing in such a way that the centre of the leaf spring linkage lies at least approximately vertically below the connecting portion. In this way, the often massive forces which acts on the bracket in accordance with the invention can be applied in a uniform manner, such that the damping sleeve or sleeves of the connection bushings are for example subjected to a load more uniformly. Other components of the bracket in accordance with the invention are also subjected to mechanical stress more uniformly due to this design, which can lead to less wear and is also helpful in avoiding damage.

Within this context, the leaf spring linkage and/or the leaf spring eye bearing is/are advantageously embodied to be substantially symmetrical with respect to the vertical direction (in this case, the Y direction), such that the leaf spring eye has at least approximately the same dimensions in the lateral direction with respect to the vertical, wherein this arrangement is helpful in channelling loads substantially vertically into the bracket in accordance with the invention and in eliminating leverage effects which could lead to excessive loads and wear.

The spring eye bearing advantageously comprises an intermediate sleeve made of vibration-damping material such as rubber or the like. Accordingly, it is also advantageous if the damping sleeve which is received by the connection bushing is likewise made of a vibration-damping material. Within this context, “vibration-damping” means that the material should have resilient characteristics and should be as permanently elastic as possible so that the bracket in accordance with the invention can perform its function over a long period of time.

The connecting device can perform its desired function using many different designs, wherein the damping sleeve can have uniform circumferential dimensions in cross-section or can be embodied to be narrower towards its centre, while the side regions are embodied to be higher. This embodiment can be helpful in centring the support sleeve when pressing the connecting device into the support sleeve. Conversely, a damping sleeve having uniform dimensions in diameter and which is uniform in the direction of the cylindrical axis of symmetry of the connection bushing except for the edge region can damp vibrations over its entire circumferential extent and therefore damp noise more uniformly. If the damping sleeve exhibits a varying thickness in the direction of the cylindrical axis of the connection bushing, the support sleeve (which is part of the connecting portion) should also be embodied to correspond to the shape of the damping sleeve.

The outer and inner lateral springs provided on the edges of the connection bushing in the direction of the axis of cylindrical symmetry of the connection bushing can likewise be embodied differently. They can be embodied to be wider or narrower in the direction of the cylindrical axis of the connection bushing or embodied to be uniform in width or of different widths.

Another aspect which can lead to more favorable assembly is to embody the connection bushing in two halves which can be symmetrical or asymmetrical. These two halves are fitted together, wherein the damping sleeve can be placed centrally on the joined portion parts or halves of the inner sleeve of the connection bushing, wherein only the pressing process requires the damping sleeve to be subjected to a minor load. A bolt such as a stud bolt, using which the connection bushing is fixed to the connecting portion and the vehicle frame, joins the two portion parts or halves of the inner sleeve.

The present invention is explained in more detail below on the basis of example embodiments by referring to the attached figures.

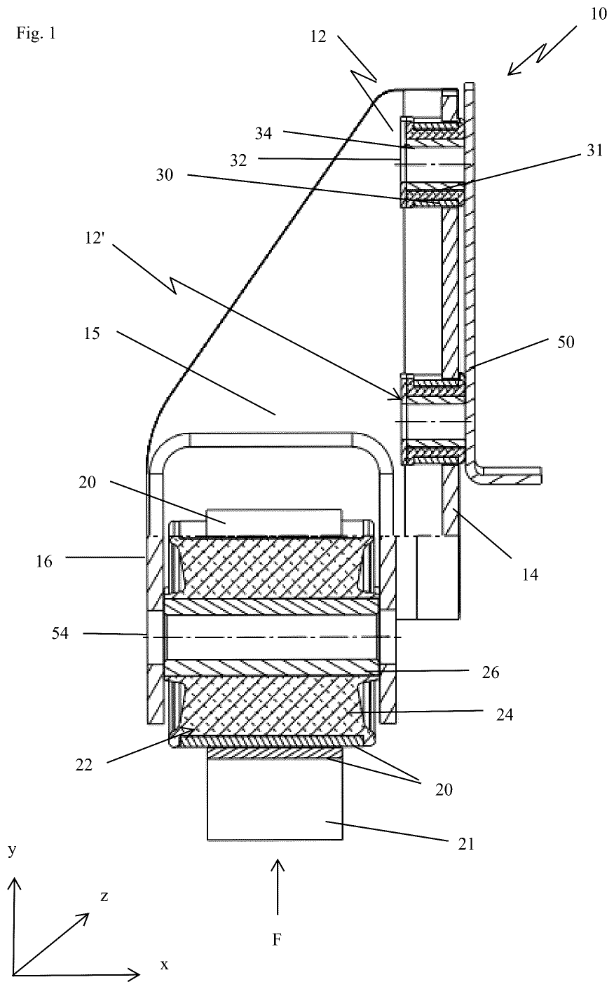

FIG. 1 shows a partial vertical central section through an embodiment of the bracket in accordance with the invention.

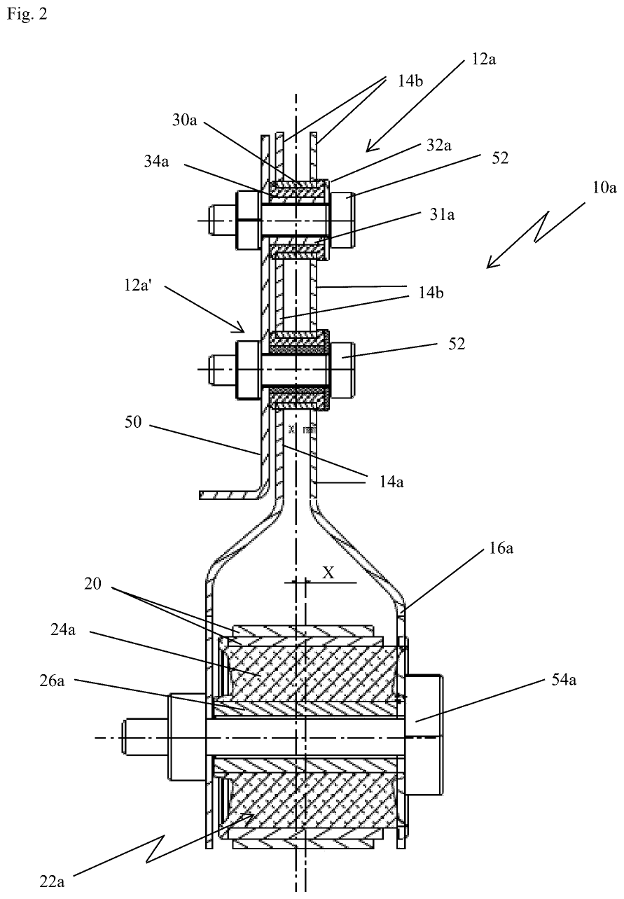

FIG. 2 shows a vertical section through another embodiment of the bracket in accordance with the invention.

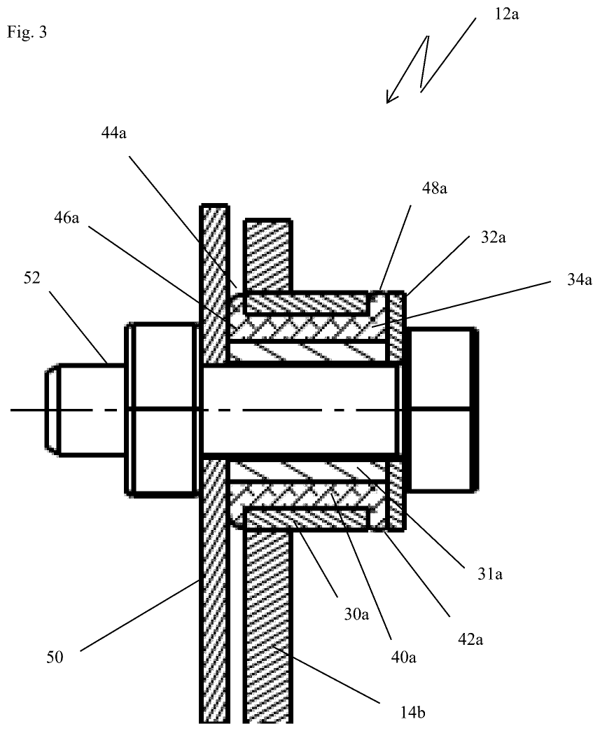

FIG. 3 shows a cross-section in the vertical direction through a connection bushing such as can be used in accordance with the embodiments according to FIGS. 1 and 2.

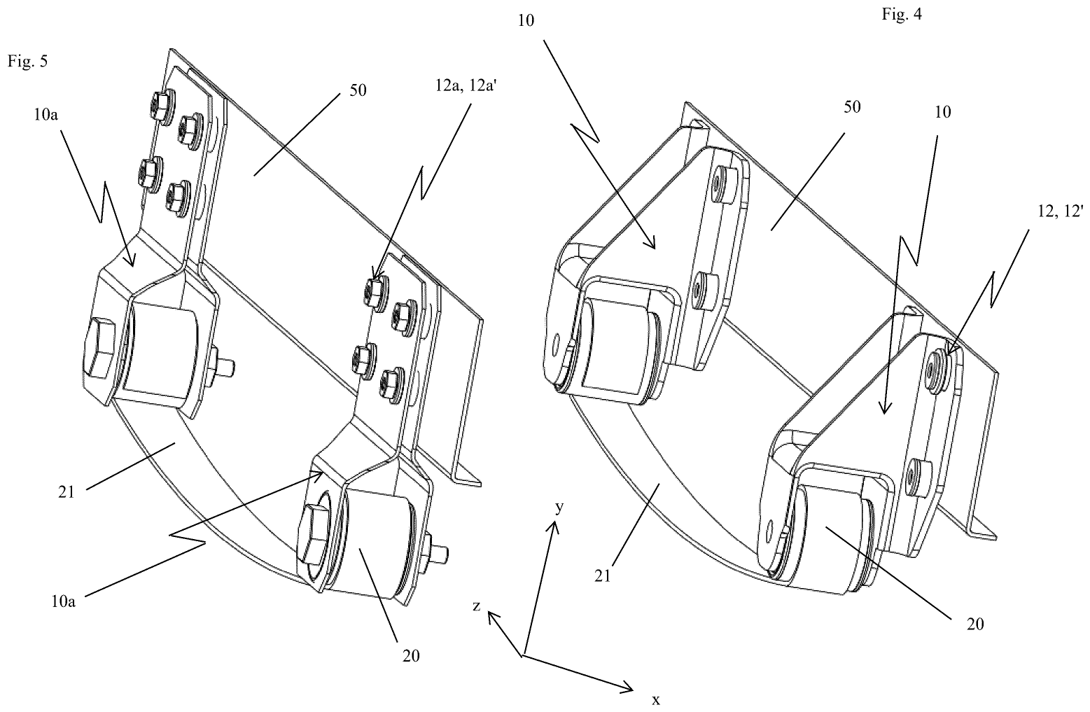

FIG. 4 shows a completed arrangement for fastening a leaf spring to a vehicle frame using the bracket in accordance with FIG. 1, in a perspective view.

FIG. 5 shows a completed arrangement for fastening a leaf spring to a vehicle frame using the bracket in accordance with FIG. 2, in a perspective view.

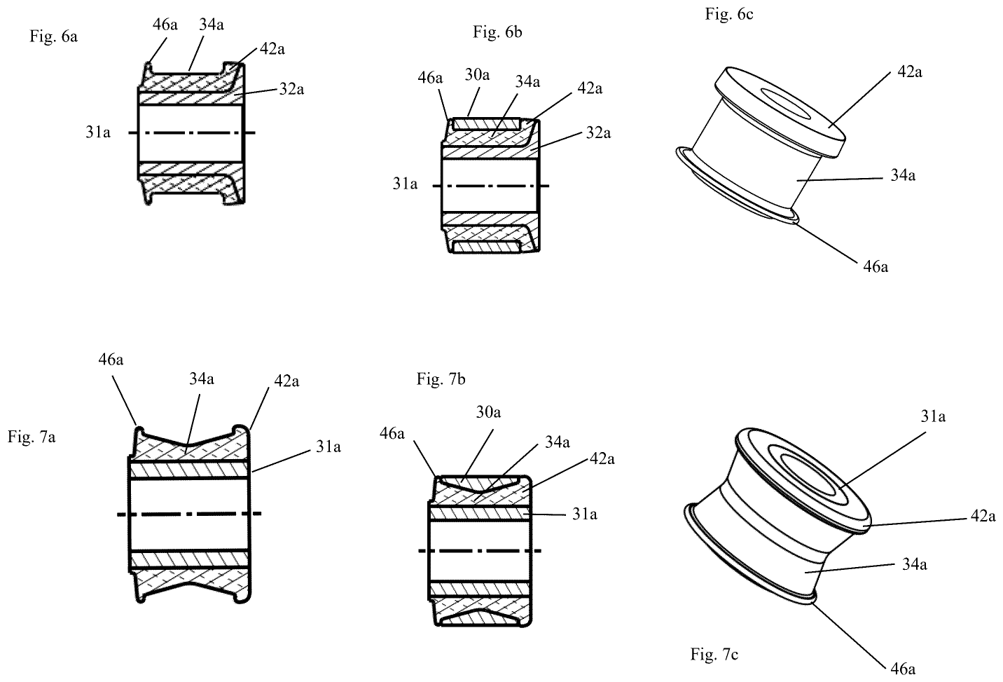

FIGS. 6a to 6c show a connection bushing in a longitudinal section along the cylindrical axis of the connection bushing (FIGS. 6a and 6b) and in a perspective view (FIG. 6c).

FIGS. 7a to 7c show representations corresponding to FIGS. 6a to 6c.

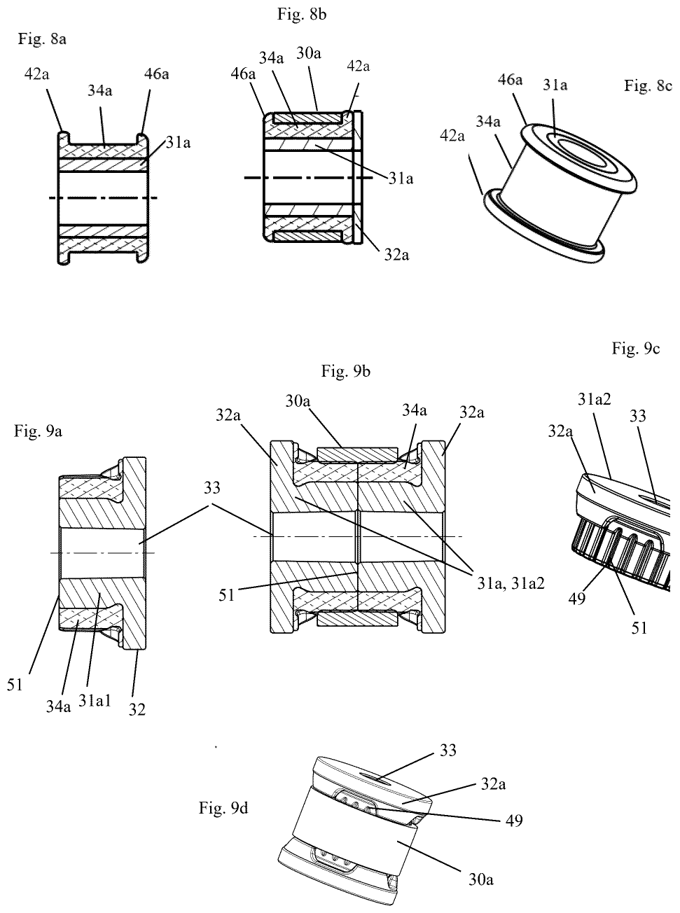

FIGS. 8a to 8c show representations of a connection bushing corresponding to the representations in accordance with FIGS. 6a to 6c.

FIGS. 9a to 9d show, in a longitudinal section on the one hand (FIGS. 9a and 9b), a two-part or halved inner sleeve of a connection bushing in accordance with the invention with a damping sleeve attached, wherein the damping sleeve can likewise be embodied in two parts, and FIGS. 9c and 9d show perspective views of an inner sleeve part.

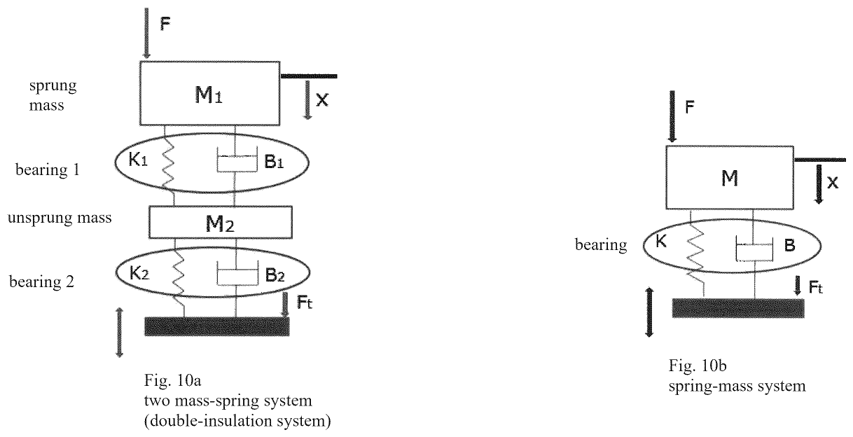

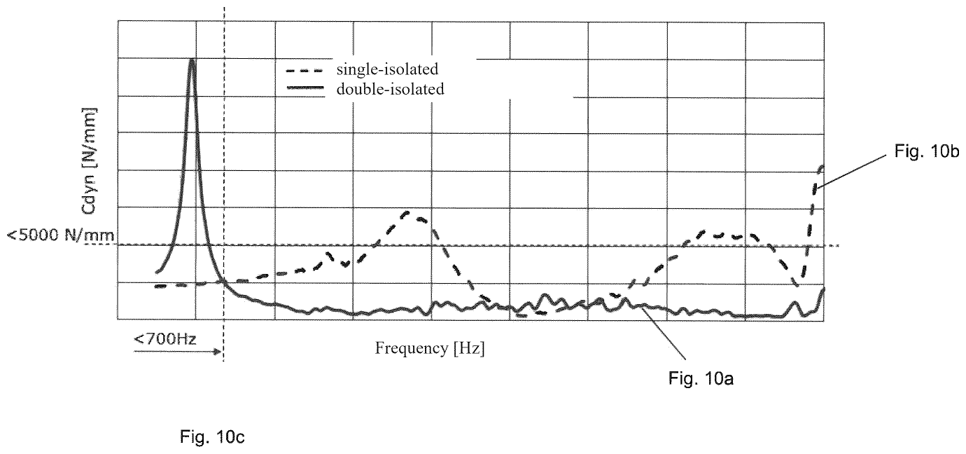

FIG. 10 shows, by way of example, a schematic representation of a kinematic system which can be mapped onto the present invention, and a spectrum of transmitted frequencies, wherein FIG. 10a schematically shows a two mass-spring system or the so-called double-isolation system in accordance with the invention, while FIG. 10b is directed to brackets in accordance with the prior art described at the beginning and depicts a schematic representation of a simple mass-spring system. FIG. 10c shows the frequency transmission spectra of the schematic arrangements in accordance with FIGS. 10a and 10b.

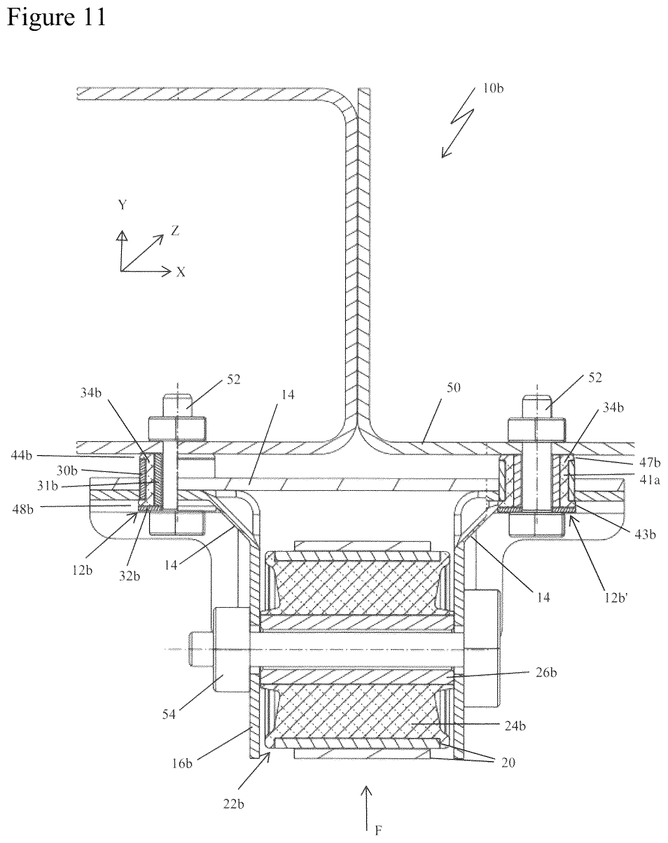

FIG. 11 shows a partial cross-section through another embodiment of the bracket in accordance with the invention.

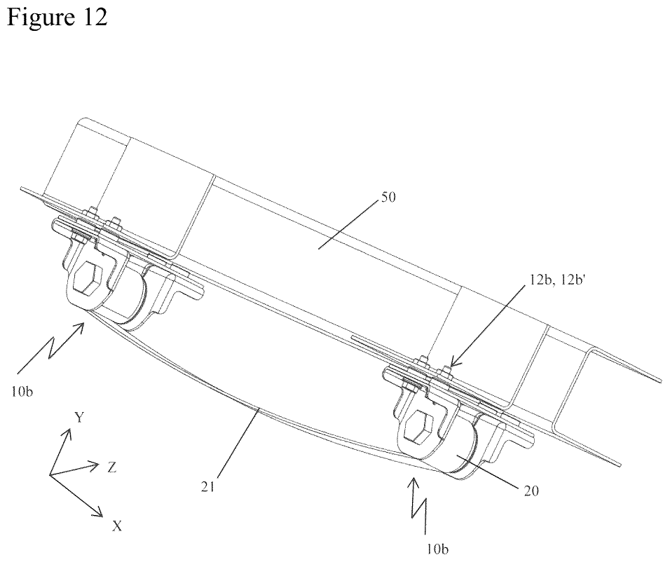

FIG. 12 shows a perspective overview of the bracket in accordance with FIG. 11 when installed.

FIG. 1 shows an embodiment of a bracket 10 in which disruptive frequencies and noise are decoupled using two different damping systems. One damping system consists of a spring eye bearing 22 which is introduced into the leaf spring eye 20 of the leaf spring 21 which is to be held. The spring eye bearing 22 comprises an intermediate sleeve 24 and an assembly sleeve 26 which can perform the function of an inner sleeve. The intermediate sleeve 24 is interposed between the assembly sleeve 26 and the leaf spring eye 20. A stud bolt can extend through the assembly sleeve 26 in order to fasten the leaf spring eye 20 to a leaf spring linkage 16 which is fastened to a vehicle frame 50 via a connecting portion 14.

The intermediate sleeve 24 can be made of a permanently elastic material such as rubber or a vibration-absorbing plastic, in particular in order to serve as a spring element or rubber spring.

A second damping component is provided by a connection bushing 12, 12′. Two such connection bushings 12, 12′ can be seen in the representation. In a particularly advantageous embodiment, however, four such connection bushings 12, 12′ are provided which can be fastened to the vehicle frame 50 via stud bolts (not shown here).

The connection bushings 12, 12′ can be embodied identically or also differently, for example with respect to their size, choice of material and their dimensions, in order to damp different frequency spectra, i.e. in order to exhibit different natural frequencies. In this way, specific frequency spectra can be damped.

A connection bushing 12, 12′ comprises a damping sleeve 34 which is provided on an inner sleeve 31. The damping sleeve can be made of a damping material such as rubber or a vibration-absorbing plastic. The damping sleeve 34 can for example be vulcanised, glued, pressed or the like onto the inner sleeve 31.

The connecting portion 14 is connected to a support sleeve 30 which rests on the outer circumference of the damping sleeve 34 of the connection bushing 12, 12′, wherein the damping sleeve 34 can be embodied in the manner of a rubber spring or a spring element. The connection bushing 12, 12′ can be pressed into the support sleeve 30.

It can be seen that a force F acts on the bracket 10 in the vertical direction (the Y direction), wherein a distance between the lateral centre (in the X direction) and the lateral centre of the connection bushing 12, 12′ leads to non-uniform loads and leverage forces which can lead to an increased load on one side. The connection bushing 12, 12′ is explained in more detail below with respect to one of its embodiments and by referring to FIG. 3.

FIG. 2 shows a bracket 10a according to another embodiment of the invention. The bracket 10a is embodied in the same way with respect to the spring eye bearing 22a and the connection bushing 12a, 12a′.

A leaf spring linkage 16a is embodied in such a way that it has been made symmetrical in the lateral direction (the X direction) in relation to a double connecting portion 14a and an appendage 14b of the double connecting portion 14a. In this way, occurrent leverage forces can be minimised and the elastic components 24a, 34a in particular can be subjected to a uniform load, in accordance with FIG. 1.

In accordance with FIG. 2, stud bolts 52, 54 are used on the one hand to fix the leaf spring eye 20 to the bracket 10a in accordance with the invention and on the other hand to fix the bracket 10a in accordance with the invention to the vehicle frame 50.

FIG. 3 depicts a connection bushing 12a such as can be used in accordance with the invention. The connection bushing 12a can of course also be embodied differently, for example in order to be able to compensate for leverage forces which can occur in the embodiment in accordance with FIG. 1. This can for example be achieved by embodying the connection bushing 12a as a whole to be approximately conical or also stepped, wherein the damping sleeve 34a can likewise be embodied to be conical, or conical but only on one side. In this way, leverage forces as well as vibration spectra which are to be equalised can be absorbed in an optimised manner.

In accordance with FIG. 3, the appendage 14b and/or the connecting portion 14 engages the connection bushing 12a via the support sleeve 30a. A gap 44a is left between the appendage 14b or connecting portion 14 and the vehicle frame 50. A portion 46a of the damping sleeve 34a can extend into this gap 44a and therefore serve as an inner lateral spring 46a. A corresponding gap 48a can be provided on the outside as an outer gap 48a in order to thus provide an outer lateral spring 42a. The outer lateral spring 42a can rest on an outer flange 32a of the connection bushing 12a, such that two spring devices (the outer lateral spring 42a and the inner lateral spring 46a) which have a vibration-damping effect are provided in the lateral direction. The damping sleeve 34a likewise extends between an inner sleeve 31a and the support sleeve 30a and therefore provides a vertical spring device. A connecting bolt 52 which is for example embodied as a stud bolt fixes the connection bushing 12a and therefore the bracket 10, 10a in accordance with the invention to the vehicle frame 50.

FIG. 4 shows a vehicle frame 50 on which a leaf spring 21 is to be mounted in accordance with the invention via spring eyes 20. In this case, the brackets 10 in accordance with the invention are used for instance according to FIG. 1, wherein connection bushings 12, 12′ such as are for example disclosed in FIGS. 6 to 9 below can be used.

Another embodiment in accordance with the invention can be seen from FIG. 5, the content of which substantially corresponds to the technical content in accordance with FIG. 4, wherein a bracket 10a in accordance with FIG. 2 is used to hold the leaf spring 21 in a damping manner on the vehicle frame 50. Connection bushings 12a, 12a′ can be embodied to correspond to the connection bushings described in the present disclosure or to correspond to modifications disclosed by the present disclosure.

FIGS. 6a to 6c show an embodiment of a connection bushing in accordance with the invention. An inner sleeve 31a has been pressed into a damping sleeve 34a. The inner sleeve 31a comprises an outer flange 32a which is intended to aid in preventing a damping sleeve 34a which has been pressed onto the inner sleeve 31a from drifting downwards towards the cylindrical axis during operation. The damping sleeve 34a comprises an outer lateral spring 42a and an inner lateral spring 46a which are designed to prevent the support sleeve 30a shown in FIG. 6b from coming into metallic contact with the other components of the bracket in accordance with the present invention. FIG. 6c shows an embodiment of the damping sleeve 34a in a perspective view.

FIGS. 7a to 7c correspond to FIGS. 6a to 6c, but show a damping sleeve 34a which tapers conically from both ends towards the centre and which is pressed onto an inner sleeve 31a, wherein the inner sleeve 31a has not in this case been embodied with an outer flange. The slightly conical shape of the damping sleeve 34a continues in the shape of the support sleeve 30a. Otherwise, an outer lateral spring 42a and an inner lateral spring 46a are again provided in this case, which are intended to prevent direct contact between the metallic components of the bracket in accordance with the invention.

FIGS. 8a to 8c also show another embodiment of a connection bushing in accordance with the present invention, wherein in this case, an outer flange 32a is provided on the inner sleeve 31a, and a damping sleeve 34a is embodied uniformly in its longitudinal section along the cylindrical axis of the connection bushing, wherein an inner lateral spring 46a and an outer lateral spring 42a are in turn provided in order to cushion and/or isolate the support sleeve 30a from the metallic components of the bracket in accordance with the invention.

FIGS. 9a to 9d show another embodiment of a connection bushing which in this case is embodied in two portions which can be referred to as inner sleeve parts 31a1, 31a2. A damping sleeve 34a can also be embodied in two portions or portion parts or can also be provided in one piece.

For the purpose of assembly, the two inner sleeve parts 31a1, 31a2 are connected to each other at their joining plane 51, wherein they can be mechanically fixed via a bolt such as a stud bolt (not shown). Corrugations 49 which are provided can aid in preventing the damping sleeve 34a from twisting, and a support sleeve 30a rests centrally (see FIG. 9b) on the connection bushing in accordance with FIGS. 9a to 9c. FIG. 9d shows the position of the support sleeve 30a relative to the connection bushing in accordance with FIGS. 9a to 9d, wherein the damping sleeve 34a has not been depicted in this case. A connecting bolt or stud bolt is guided through a central passage opening part 33 in order to fasten the two inner sleeve parts 31a1, 31a2.

The embodiment shown in FIGS. 9a to 9d can provide advantages in assembly and, if for example another damping element is also introduced along the joining plane 51, additional damping characteristics can be provided.

FIG. 10 shows three systems for absorbing forces and vibrations. FIG. 10b shows conditions such as occur if only one spring eye bearing 22, 22a were provided, i.e. if only one assembly performs the damping function. As can be seen in FIG. 10c, vibration maxima are then transmitted, especially in the audible or tactile range, which can be extremely disruptive.

FIG. 10a shows the double system in accordance with the two embodiments of the invention, wherein two damping systems are provided. One damping system is provided by the connection bushing 12, 12′, 12a, 12a′ in accordance with the invention, and the other damping system is provided by the spring eye bearing 22, 22a.

As can be seen from FIG. 10c, the transmission maxima in accordance with the curve according to FIG. 10b have been almost eliminated and vibrations and/or noise are transmitted in accordance with FIG. 10a in this range. A maximum at the beginning of the frequency curve in accordance with FIG. 10a lies within a very low-frequency range and is thus hardly relevant in reality.

The double damping system in accordance with the invention therefore shows surprisingly effective vibration damping, in particular of vibrations which can be generated by the gears of a transmission and are in a range of for example 400 to 700 Hz and can thus be both heard and felt.

FIG. 11 shows another embodiment of a bracket 10b in accordance with the invention. The bracket 10b is fixed to the vehicle frame 50 in a vertical alignment towards the Y axis.

In this case, connection bushings 12b, 12b′ are provided which are fixed to the vehicle frame 50 in the vertical direction, wherein the design which is assigned to the leaf spring 21 (see FIG. 12) along with the leaf spring eye 20 is held on the vehicle frame 50 via a connecting bolt 52. The respective connection bushings 12b, 12b′ are in principle embodied in the same way as the connection bushings described above, wherein the connection bushings described above were aligned laterally, whereas in accordance with the present embodiment, they are aligned vertically.

A lateral spring 41a is realised by a damping sleeve 34b, wherein an outer horizontal spring 43b and an inner horizontal spring 47b are simultaneously realised, which are situated in an outer gap 48b and in an inner gap 44b. The outer gap 48b and the inner gap 44b are achieved by providing an abutting sleeve 30b which is embodied to be vertically shorter than an inner sleeve 31b. The damping sleeve 34b, which is preferably made of a permanently elastic rubber, plastic or the like, is inserted, in particular pressed in, between the abutting sleeve 30b and the inner sleeve 31b. An outer flange 32b on one side and a counter bearing provided by the vehicle frame 50 limit the spread of the damping sleeve 34b. The leaf spring 21 shown in FIG. 12, along with the leaf spring eye 20 shown in FIG. 11 and the components provided on it such as the spring eye bearing 22b, the intermediate sleeve 24b and the assembly sleeve 26b which are held on the connecting portion 14 via the retaining bolt 54, are embodied in the same way as has already been described above in relation to the other embodiments in accordance with the invention.

FIG. 12 shows the embodiment in accordance with FIG. 11 when installed on a vehicle frame 50. The connection bushings 12b, 12b′ are aligned vertically. In this case, two brackets 10b are used which are each held on the vehicle frame 50 via two connection bushings 12b, 12b′. The leaf spring 21 is fastened to the vehicle frame 50 via the leaf spring eyes 20 and the respective brackets 10b.

### LIST OF REFERENCE SIGNS

10, 10a, 10b bracket
12, 12′, 12a, 12a′, 12b, 12b′ connection bushing
14 connecting portion
14a double connecting portion
14b appendage
15 angular portion
16, 16a, 16b leaf spring linkage
20 leaf spring eye
21 leaf spring
22, 22a, 22b spring eye bearing
24, 24a, 24b intermediate sleeve
26, 26a, 26b assembly sleeve
30, 30a support sleeve
30b abutting sleeve
31, 31a, 31b inner sleeve
31a1, 31a2 inner sleeve part
32, 32a, 32b outer flange
33 passage opening part
34, 34a, 34b damping sleeve
40a vertical spring
41a lateral spring
42a outer lateral spring
43b outer horizontal spring
44a, 44b inner gap
46a inner lateral spring
47b inner horizontal spring
48a, 48b outer gap
49 corrugations
50 vehicle frame
51 joining plane
52 connecting bolt
54 retaining bolt
54a spring stud bolt

1. A bracket for a leaf spring on a vehicle frame comprising:
a leaf spring linkage via which an eye of the leaf spring is held;
a spring eye bearing which is inserted into the eye of the leaf spring;
a connecting portion which connects the leaf spring linkage to the vehicle frame; and
at least one connection bushing via which the connecting portion can be mounted on the vehicle frame,
wherein the connection bushing is provided with a damping sleeve which is interposed in a damping manner between the connecting portion and the vehicle frame.

2. The bracket according to claim 1, wherein the damping sleeve is embodied to be vertically and/or laterally resilient.

3. The bracket according to claim 1 further comprising a support sleeve, to which the connecting portion is attached and which rests on the connection bushing.

4. The bracket according to claim 1 further comprising an abutting sleeve which the connecting portion laterally rests on and which laterally rests on the connection bushing (12b, 12b′).

5. The bracket according to claim 3 wherein the support sleeve is embodied to be laterally narrower than the damping sleeve.

6. The bracket according to claim 1 wherein the abutting sleeve is embodied to be vertically narrower than the damping sleeve.

7. The bracket according to claim 3 further comprising a gap laterally between the support sleeve and the vehicle frame and/or between the support sleeve and an outer flange.

8. The bracket according to claim 4 further comprising a gap vertically between the abutting sleeve and the vehicle frame and/or between the abutting sleeve and an outer flange.

9. The bracket according to claim 1 wherein the leaf spring linkage is arranged at least substantially vertically below the at least one connection bushing in such a way that the centre of the leaf spring linkage lies approximately vertically below the connecting portion.

10. The bracket according to claim 1 wherein at least one of the leaf spring linkage or the spring eye bearing is embodied to be substantially symmetrical with respect to the vertical direction (Y), such that the leaf spring eye is at least approximately equally extended in a lateral direction (X) with respect to the vertical (Y).

11. The bracket according to claim 1 wherein the spring eye bearing comprises an intermediate sleeve and at least one of the intermediate sleeve or the damping sleeve is made of a vibration-damping material.
